(19) United States
(12) Patent Application Publication
(10) Pub. No.: US 2017/0198577 A1
(43) Pub. Date: Jul. 13, 2017

(54) Rotatable Cutting Tool

(71) Applicant: Caterpillar Inc., Peoria, IL (US)

(72) Inventors: Andrew D. Steinmetz, Peoria, IL (US); Robert Carr, Sebastian, FL (US); Timothy Arthur Thorson, Morton, IL (US); Conwell K. Rife, Wayzata, MN (US); Thierry Marchione, Heber City, UT (US)

(73) Assignee: Caterpillar Inc., Peoria, IL (US)

(21) Appl. No.: 15/276,288

(22) Filed: Sep. 26, 2016

Related U.S. Application Data
(63) Continuation-in-part of application No. 14/994,391, filed on Jan. 13, 2016.

(51) Int. Cl. E21C 35/183; C21D 9/00; E21C 35/19; C23C 30/00; B23K 26/34; B23B 27/00

(52) U.S. Cl. CPC E21C 35/183; B23K 26/34; B23B 27/00; E21C 35/19; C23C 30/005; C21D 9/0068; B23B 2228/10; B23B 2222/16; E21C 2035/1806

(57) ABSTRACT

A method for fabricating a rotatable cutting tool is disclosed. The method may comprise fabricating a body of a holder for the cutting tool, wherein the body of the holder extends along an axis and includes a head portion and a shank portion. The head portion may extend from a first end to a second end, and the first end may be configured to receive a cutting tip. The method may further comprise applying a plurality of rotation-assisting strips along an outer surface of the head portion that extend between the first end and the second end. The rotation-assisting strips may project from the outer surface of the head portion. The method may further comprise heat treating the holder having the plurality of rotation-assisting strips.

### CROSS-REFERENCE TO RELATED APPLICATION

This application is a continuation-in-part pursuant to 35 U.S.C. §120 of U.S. patent application Ser. No. 14/994,391 filed on Jan. 13, 2016.

### TECHNICAL FIELD

The present disclosure relates to cutting tools and, more specifically, to rotatable cutting tools with wear resistance and rotation assistance features.

### BACKGROUND

Cutting tools may be used for machining or breaking down and degrading structures such as rock, asphalt, paved surfaces, coal, metals, concrete and/or other natural or man-made formations for such applications as mining, road conditioning, and excavating. Examples of such cutting tools include, but are not limited to, asphalt milling picks, drill bits, mining picks, hammers, indenters, shear cutters, indexable cutters, and other engagement tools. For instance, cold planer machines may include a plurality of picks displayed on a drum that rotate to remove a paved surface prior to application of a new paved surface. Cutting tools may include a holder and a cutting tip. The cutting tip may be brazed to the holder and may include a carbide cutting tip.

However, in current cutting tool designs, failure of the holder may occur before the cutting tip is completely worn out. This leads to wasted usable life of the cutting tip and extra owning and operating costs for end-users. The failure of the holder before the cutting tip is completely worn out also reduces replacement interval time, which is not desirable.

U.S. Pat. No. 8,753,755 describes a body, such as a pick tool for cutting coal. The pick tool includes a steel substrate and a hard face structure fused to the steel substrate. The hard face structure includes at least 1 weight percent silicon (Si), at least 5 weight percent chromium (Cr), and at least 40 weight percent tungsten (W). Substantially the balance of the hard face structure includes carbon and an iron group metal M selected from iron (Fe), cobalt (Co), nickel (Ni), and alloy combinations of these elements. The hard face structure includes a plurality of elongate or platelike micro-structures having a mean length of at least 1 micron, a plurality of nano-particles having a mean size of less than 200 nanometers, and a binder material.

In addition, rotatable cutting tools, such as asphalt milling tools and drill bits, may not rotate consistently during use. For example, such cutting tools may slow or stop rotation occasionally during operation. Inconsistent rotation of the cutting tool may cause uneven wear around the circumference of the carbide cutting tip and/or the holder over time. Due to uneven wear, the cutting tool may need to be replaced more frequently, adding to operation costs. In such cases, supporting proper rotation of the cutting tool may be key to promoting even wear around the circumference of the cutting tool and extending the service life of the cutting tool.

U.S. Pat. No. 7,464,993 discloses an attack tool for asphalt milling and mining that includes a base having a shank for attachment to a driving mechanism, and a frustoconical metal carbide segment having a first end bonded to the base and a second end bonded to a second metal carbide segment. In one example, the patent further discloses hard inserts bonded to the base that may aid in rotation of the tool. The inserts may comprise materials such as diamond, cubic boron nitride, and carbides. While effective, there is a need for enhanced designs for rotatable cutting tools that prevent wear of the holder and/or support rotation of the cutting tool to prevent uneven wear of the cutting tool.

### SUMMARY

In accordance with one aspect of the present disclosure, a method for fabricating a rotatable cutting tool is disclosed. The method may comprise fabricating a body of a holder of the rotatable cutting tool. The body of the holder may extend along an axis and may include a head portion and a shank portion. The head portion may extend from a first end to a second end. The first end of the head portion may be configured to receive a cutting tip. The method may further comprise applying a plurality of rotation-assisting strips along an outer surface of the head portion that extend between the first end and the second end. The rotation-assisting strips may project from the outer surface of the head portion. The method may further comprise heat treating the holder having the plurality of rotation-assisting strips.

In accordance with another aspect of the present disclosure, a rotatable cutting tool including a holder and a cutting tip is disclosed. The rotatable cutting tool may be fabricated by a method comprising fabricating a body of the holder, wherein the body extends along an axis and includes a head portion and a shank portion. The head portion may extend from a first end to a second end, and the first end of the head portion may be configured to receive the cutting tip. The method may further comprise creating a groove along an outer surface of the head portion proximal to the first end. The groove may extend circumferentially about the head portion. The method may further comprise forming a wear resistant layer in the groove, wherein the wear resistant layer has an outer surface that conforms to an outer surface of the head portion. In addition, the method may further comprise applying a plurality of rotation-assisting strips on the outer surface of the head portion and the outer surface of the wear resistant layer. The rotation-assisting strips may extend between the first end and the second end, and may project from the outer surface of the head portion and the outer surface of the wear resistant layer. The method may further comprise heat treating the holder having the wear resistant layer and the rotation-assisting strips.

In accordance with another aspect of the present disclosure, a rotatable cutting tool is disclosed. The rotatable cutting tool may comprise a holder having a body extending along an axis and including a head portion and a shank portion. The head portion of the holder may extend from a first end to a second end. The rotatable cutting tool may further comprise a wear resistant layer extending circumferentially about the head portion proximal to the first end of the head portion. The wear resistant layer may have an outer surface that conforms to an outer surface of the head portion. In addition, the rotatable cutting tool may comprise a plurality of rotation-assisting strips extending axially along the outer surface of the head portion between the first end and the second end, with the rotation-assisting strips projecting from the outer surface of the head portion. The holder may be heat treated after the application of the wear resistant layer and rotation-assisting strips to the head portion. In addition, the rotatable cutting tool may comprise a cutting tip coupled to the first end of the head portion.

These and other aspects and features of the present disclosure will be more readily understood when read in conjunction with the accompanying drawings.

### BRIEF DESCRIPTION OF THE DRAWINGS

FIG. 1 is a perspective view of an exemplary rotatable cutting tool having a holder, constructed in accordance with the present disclosure.

FIG. 2 is a perspective view similar to FIG. 1, but with a conical cutting tip, constructed in accordance with the present disclosure.

FIG. 3 is a cross-sectional view of the holder of the cutting tool of FIG. 1, the holder having a groove formed in a head portion of the holder, constructed in accordance with the present disclosure.

FIG. 4 is a cross-sectional view similar to FIG. 3, but with the groove having an different shape, constructed in accordance with the present disclosure.

FIG. 5 is a cross-sectional view of the cutting tool similar to FIG. 3, but having a wear resistant layer in the groove, constructed in accordance with the present disclosure.

FIG. 6 is a cross-sectional view similar to FIG. 5, but with the wear resistant layer resistant layer being below an outer surface of the head portion, constructed in accordance with the present disclosure.

FIG. 7 is a cross-sectional view similar to FIG. 5, but with the wear resistant layer extending above the outer surface of the head portion, constructed in accordance with the present disclosure.

FIG. 8 is a perspective view of the holder having the wear resistant layer, constructed in accordance with the present disclosure.

FIG. 9 is a perspective view similar to FIG. 8, but with the wear resistant layer extending to an upper surface of the head portion, constructed in accordance with the present disclosure.

FIG. 10 is a perspective view similar to FIG. 9, but with the wear resistant layer applied only to the upper surface of the head portion, constructed in accordance with the present disclosure.

FIG. 11 is perspective view of the cutting tool similar to FIG. 1, but having rotation-assisting strips applied to the head portion, constructed in accordance with the present disclosure.

FIG. 12 is a perspective view of the cutting tool similar to FIG. 11, but lacking an annular recess at a second end of the head portion, constructed in accordance with the present disclosure.

FIG. 13 is a top view of the cutting tool of FIG. 11, constructed in accordance with the present disclosure.

FIG. 14 is a perspective view of the cutting tool similar to FIG. 11, but having the rotation-assisting strips applied to the head portion in a helical pattern, constructed in accordance with the present disclosure.

FIG. 15 is a perspective view of the cutting tool similar to FIG. 11, but with the rotation-assisting strips joined at a first end of the head portion, constructed in accordance with the present disclosure.

FIG. 16 is a perspective view of the cutting tool similar to FIG. 11, but with the rotation-assisting strips being narrower at the first end of the head portion, constructed in accordance with the present disclosure.

FIG. 17 is a cross-sectional view of the cutting tool of FIG. 11, constructed in accordance with the present disclosure.

FIG. 18 is a cross-sectional view similar to FIG. 17, but with the rotation-assisting strips being applied on the wear resistant layer, constructed in accordance with the present disclosure.

FIG. 19 is a cross-sectional view similar to FIG. 18, but with the rotation-assisting strips applied only on an outer surface of the head portion, constructed in accordance with the present disclosure.

FIG. 20 is a cross-sectional view similar to FIG. 17, but with the rotation-assisting strips being formed within grooves along the head portion, constructed in accordance with the present disclosure.

FIG. 21 is a cross-sectional view similar to FIG. 20, but with the rotation-assisting strips being flush with the outer surface of the head portion, constructed in accordance with the present disclosure.

FIG. 22 is a cross-sectional view similar to FIG. 20, but with the rotation-assisting strips being below the outer surface of the head portion, constructed in accordance with the present disclosure.

FIG. 23 is a flowchart of a method of selectively hardfacing the holder of the cutting tool, in accordance with a method of the present disclosure.

FIG. 24 is a flowchart depicting a series of steps that may be involved in fabricating the cutting tool, in accordance a method of the present disclosure.

FIG. 25 is flowchart depicting a series of steps that may be involved in fabricating the cutting tool, in accordance with another method of the present disclosure.

### DETAILED DESCRIPTION

FIG. 1 is a perspective view of a cutting tool 100, according to one embodiment of the present disclosure. The cutting tool 100 may be used for machining, breaking into, boring, or degrading structures such as rock, asphalt, coal, metals, or concrete. The cutting tool 100 may be used in applications including, but not limited to, mining, construction, excavation, and road reconditioning. The cutting tool 100 may be selected from the group consisting of drill bits, asphalt picks, mining picks, hammers, indenters, shear cutters, indexable cutters, and combinations thereof, without any limitations.

In one example, the cutting tool 100 may be used in metal working applications, and can be mounted on a machine tool (not shown), such as a milling machine, lathe, or the like. In another example, a number of the cutting tools 100 may be mounted on a rotatable drum and operated to break up road asphalt, rock formations in coal mining, etc., based on a rotation of the drum.

The cutting tool 100 may include a holder 102. The holder 102 may include an elongated body 103 that extends along an axis 105. In one example, the holder 102 may be made of a metal including, but not limited to, steel. For example, the holder 102 may be made of carbon steel, without limiting the scope of the present disclosure. The body 103 of the holder 102 may include a shank portion 104. The shank portion 104 may be generally cylindrical in cross-section, as shown.

A sleeve 106 of the cutting tool 100 may surround the shank portion 104. The sleeve 106 allows mounting of the cutting tool 100 in a socket (not shown) attached to a rotatable member such as the drum. The sleeve 106 may tightly engage the socket and loosely engage the shank portion 104, thereby allowing the cutting tool 100 to rotate during use. The sleeve 106 may be slotted and may be made of a resilient material. The sleeve 106 may extend between an upper flange 108 and a lower flange 110 of the holder 102. The upper flange 108 and the lower flange 110 may have diameters which are greater than that of the socket.

The body 103 of the holder 102 may further include a head portion 112. The head portion 112 may be coupled to the shank portion 104 and may extend between a first end 114 and a second end 116. The head portion 112 may be generally frustoconical or conical in shape. The head portion 112 and the shank portion 104 may be manufactured as a unitary piece. Alternatively, the head portion 112 and the shank portion 104 may be manufactured as separate pieces and later assembled to form the holder 102. The second end 116 of the head portion 112 may be axially separated from the upper flange 108 by an annular recess 120. The annular recess 120 may permit a user to grasp the cutting tool 100 with a specialized tool and pull it out of the socket. In alternative arrangements, the cutting tool 100 may lack the annular recess 120.

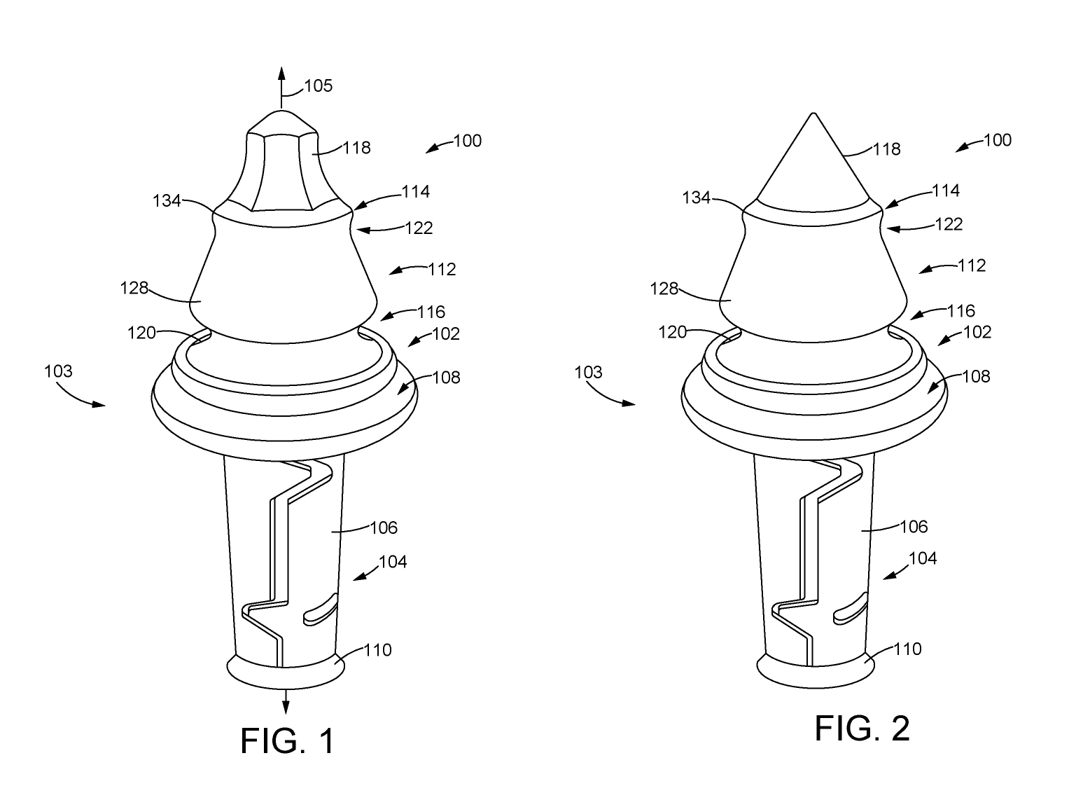

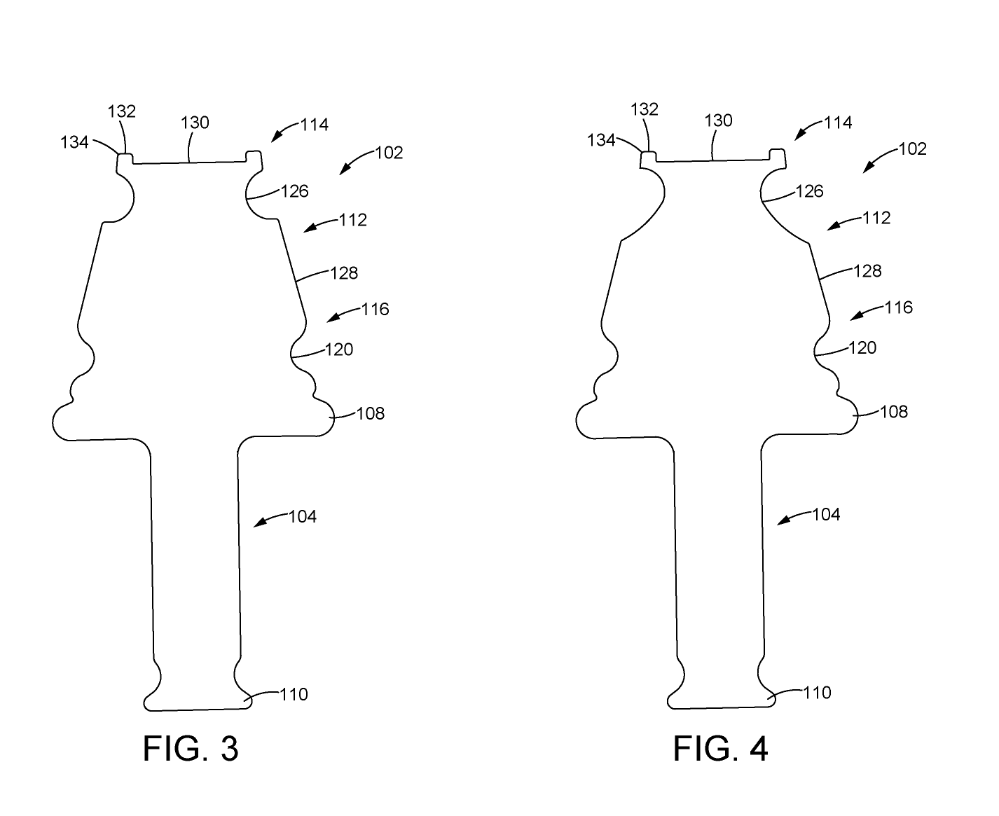

The first end 114 of the head portion 112 may include a cutting tip 118. The cutting tip 118 may have various shapes such as a bullet shaped design. The cutting tip 118 may be multi-faceted as shown in FIG. 1, or it may be smooth as shown in FIG. 2. For example, the cutting tip 118 may have a smooth, conical shape (see FIG. 2) or a circular shape. The cutting tip 118 may be coupled to the first end 114 of the head portion 112. In one example, the cutting tip 118 may be cemented or brazed to the head portion 112 into a cavity 130 (see FIG. 3) formed at the first end 114. Alternatively, any known coupling process may be used to couple the cutting tip 118 with the head portion 112, without any limitations. In one example, the cutting tip 118 may be made of a wear resistant material, such as carbide. For example, the cutting tip 118 may be made of a cemented tungsten carbide. In alternative examples, the cutting tip 118 may include a material such as polycrystalline diamond.

Referring to FIG. 3, the head portion 112 of the holder 102 may include a groove 126. The groove 126 may be created in the holder 102 proximal to the first end 114 of the head portion 112 that receives the cutting tool tip 118. In one example, the groove 126 may be created by a metal removing process, such as machining In another example, the groove 126 may be created in the holder 102 during the manufacturing of the holder 102. For example, the groove 126 may be created during molding or casting of the holder 102. In yet another example, the groove 126 may be created during a forging process.

The groove 126 may extend circumferentially about the head portion 112 of the holder 102. The groove 126 may include a shape that corresponds to a wear pattern of the head portion 112. In one example, the groove 126 may include a concave arcuate cross-sectional configuration. In another example, the groove 126 may include a conic undercut. However, in other embodiments, the shape of the groove 126 may vary. For example, the groove 126 may include a rectangular cross-sectional configuration, a semi-circular cross-sectional configuration, a trapezoid cross-sectional configuration, and the like, without limiting the scope of the present disclosure. For instance, as shown in FIG. 4, the groove 126 may be longer in the axial direction and optionally deeper near the first end 114.

The holder 102 of the cutting tool 100 may be subject to wear and tear during operation of the cutting tool 100. More particularly, a portion 122 (see FIGS. 1 and 2) of the head portion 112 of the holder 102 proximal to the first end 114 may be subject to wear that may cause premature failure of the holder 102. The wear experienced at the first end 114 may cause reduction in dimensions at the head portion 112 of the holder 102.

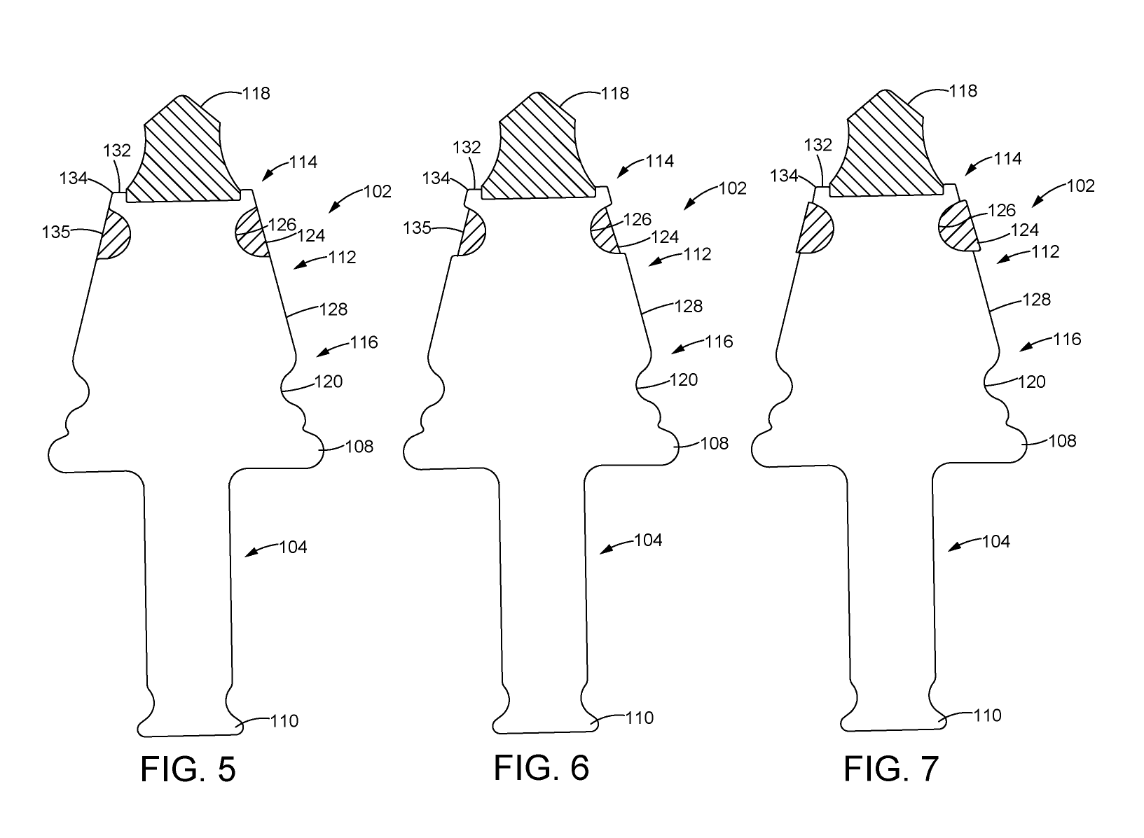

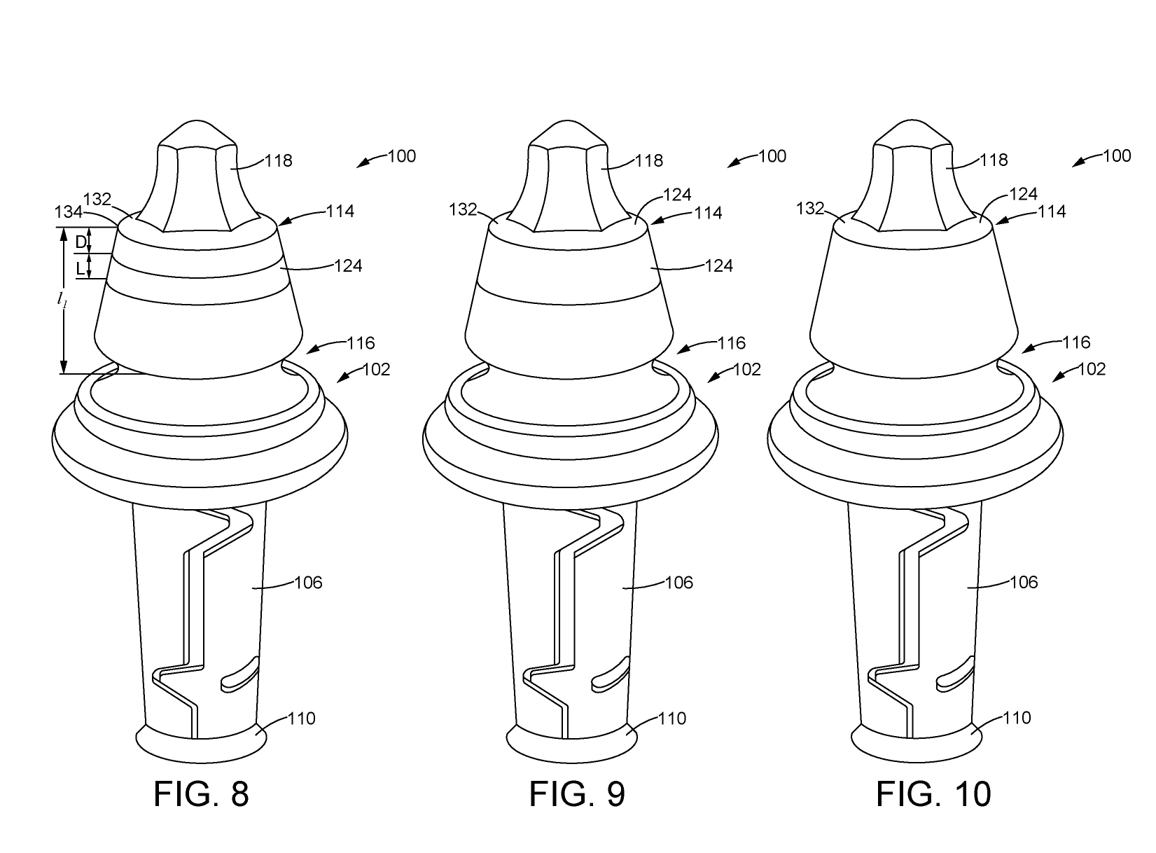

In order to mitigate the failure of the holder 102 due to wear, the head portion 112 of the holder 102 may be selectively hardfaced by providing one or more wear resistant layers 124. Referring to FIG. 5, the wear resistant layer 124 may be proximal to the first end 114 of the head portion 112. In some examples, the wear resistant layer 124 may be provided on an outer surface 128 of the head portion 112, and may extend axially from an upper periphery 134 defined by an upper surface 132. The upper surface 132 may be defined at the head portion 112 of the holder 102. The wear resistant layer 124 may be formed within the groove 126 of the head portion 112 (see FIG. 5). The wear resistant layer 124 may conform to the outer surface 128 of the holder 102. For instance, the wear resistant layer 124 may have an outer surface 135 that is flush with the outer surface 128 of the holder 102 (see FIG. 5). The wear resistant layer 124 may be formed by applying a wear resistant material in the groove 126. In one example, the wear resistant material may be cladded within the groove 126 of the holder 102. In some arrangements, such as with a deeper conic undercut (see FIG. 4), two or more layers of wear resistant material may be applied in the groove 126 to form the wear resistant layer 124. In addition, in alternative arrangements, the wear resistant layer 124 may be below the outer surface 128 of the head portion 112 as shown in FIG. 7 to permit exposure of the wear resistant layer 124 as the outer surface 128 of the head portion 112 wears away faster than the wear resistant layer 124. Alternatively, the wear resistant layer 124 may be above or project from the outer surface 128 of the head portion 112 as shown in FIG. 8. Alternatives such as these, and combinations thereof, also fall within the scope of the present disclosure.

The wear resistant material may be cladded within the groove 126 created on the outer surface 128 of the holder 102. The wear resistant material may include a hard particle material, or a matrix of a hard particle material and a metal. Further, the wear resistant material may include a hard particle precipitating material, or a matrix of a hard particle precipitation material and a metal. In some examples, the wear resistant material includes a carbide, a boride, and/or cermet. In one example, the wear resistant material includes a carbide former or boride former. In another example, the wear resistant material includes a solid state carbide or a solid state boride. It should be noted that the wear resistant material may include any composition that resists wear during operation of the cutting tool 100.

It should be noted that the wear resistant material may be chosen based on the operation that the cutting tool 100 performs and also the amount of stress or wear on the head portion 112 during operation. Further, a dimension of the groove 126 (and the wear resistant layer 124) may vary based on an amount of stress or wear on the head portion 112, or a dimension of the cutting tool 100.

In one example, a laser cladding process may be used to provide the wear resistant layer 124 in the groove 126. The laser cladding process may include any one or both of a powder laser cladding process or a wired laser cladding process. Further, the wear resistant material can be provided in the groove 126 by a metal deposition process or a metal spraying process. Any one of a thermal spray coating process, a vapor deposition process, or a chemical vapor deposition process may be used to provide the wear resistant material in the groove 126. Alternatively, any known method may be employed to clad the wear resistant material in the groove 126.

FIG. 8 is a perspective view of the cutting tool 100 having the wear resistant layer 124. In the illustrated example, the wear resistant layer 124 has a length “L” measured in an axial direction. It should be noted that the length “L” of the wear resistant layer 124 depicted in the accompanying figure is exemplary in nature. In some examples, the length “L” of the wear resistant layer 124 may be greater than or equal to one half of an overall axial length “l₁” of the head portion 112 of the holder 102, without limiting the scope of the present disclosure.

Further, the wear resistant layer 124 may be located at a distance “D” measured in an axial direction from the upper surface 132 of the head portion 112 of the holder 102. In an example where the groove 126 is embodied as the conic undercut, the wear resistant layer 124 may extend axially from the upper periphery 134 defined by the upper surface 132. In such an example, the distance “D” may be approximately equal to zero. It should be noted that the length “L” and the distance “D” may be optimally selected in order to effectively mitigate wear of the holder 102. The length “L” and the distance “D” may be varied based on operational requirements. Alternatively, the wear resistant layer 124 may also be applied to the upper surface 132 as shown in FIG. 9. As yet another possibility, the wear resistant layer 124 may be applied only to the upper surface 132 as shown in FIG. 10. For example, application of the wear resistant layer 124 to the upper surface 132 may be carried out before the cutting tip 118 is coupled to the first end 114 of the holder 102.

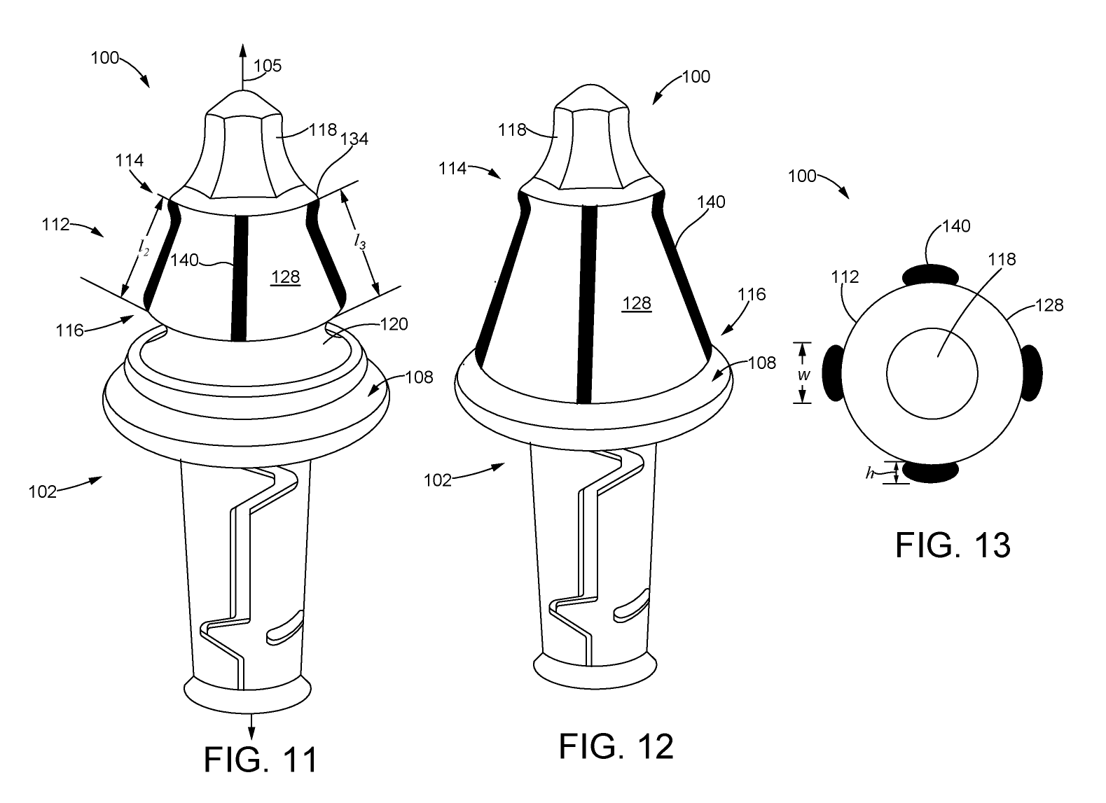

Referring now to FIGS. 11-13, the cutting tool 100 may include one or more rotation-assisting strips 140 applied to the outer surface 128 of the head portion 112. The rotation-assisting strips 140 may project from the outer surface 128 of the head portion 112, and may act as fins or ribs that assist in propelling the cutting tool 100 as it is drilling or boring into a structure (see FIG. 13). As such, the strips 140 may promote rotation of the cutting tool 100, thereby preventing uneven wear about the circumference of the cutting tip 118 and/or the holder 102. By reducing uneven wear of the cutting tool 100, the rotation-assisting strips 140 may advantageously extend the service life of the cutting tool 100.

The rotation-assisting strips 140 may extend from the first end 114 (e.g., from the upper periphery 134) to the second end 116 along the outer surface 128 of the head portion 112 with each of the strips 140 having a length (l₂) that is equal to a length (l₃) of the head portion 112 (see FIG. 11). If the cutting tool 100 includes the annular recess 120, the second end 116 of the head portion 112 may be disposed above the annular recess 120 such that the strips 140 terminate above the annular recess 120 (see FIG. 11). If the cutting tool 100 lacks the annular recess 120 as shown in FIG. 12, the second end 116 of the head portion 112 may be disposed above the upper flange 108 such that the strips 140 terminate above the upper flange 108. Alternatively, the length (l₂) of the strips 140 may be less than the length (l₃) of the outer surface 128 such that the strips 140 extend somewhere between the first end 114 and the second end 116. As yet another possibility, the strips 140 may have variable lengths (l₂) with some of the strips 140 being longer than others.

Furthermore, in some arrangements, the cutting tool 100 may have at least four or at least five of the rotation-assisting strips 140. In other arrangements, the cutting tool 100 may have any number of the rotation-assisting strips 140. In addition, as shown in FIG. 13, the strips 140 may be equally spaced about the circumference of the head portion 112. Alternatively, the strips 140 may be unevenly spaced or asymmetrically distributed about the circumference of the head portion 112. Moreover, each of the strips 140 may have a width (w) and a height (h) (see FIG. 13). The widths (w) of the strips 140 may be greater than the heights (h) of the strips 140. Alternatively, the widths (w) of the strips 140 may be equal to or less than the heights (h) of the strips 140. In any event, each of the strips 140 may project from the outer surface 128 of the head portion 112 by a distance that is equal to the height (h) of the strip 140 (see FIG. 13). For example, the heights (h) of the strips 140 may range from about 0.1 millimeters (mm) to about 10 mm, although the heights may deviate substantially from this range depending on the dimensions of the cutting tool 100.

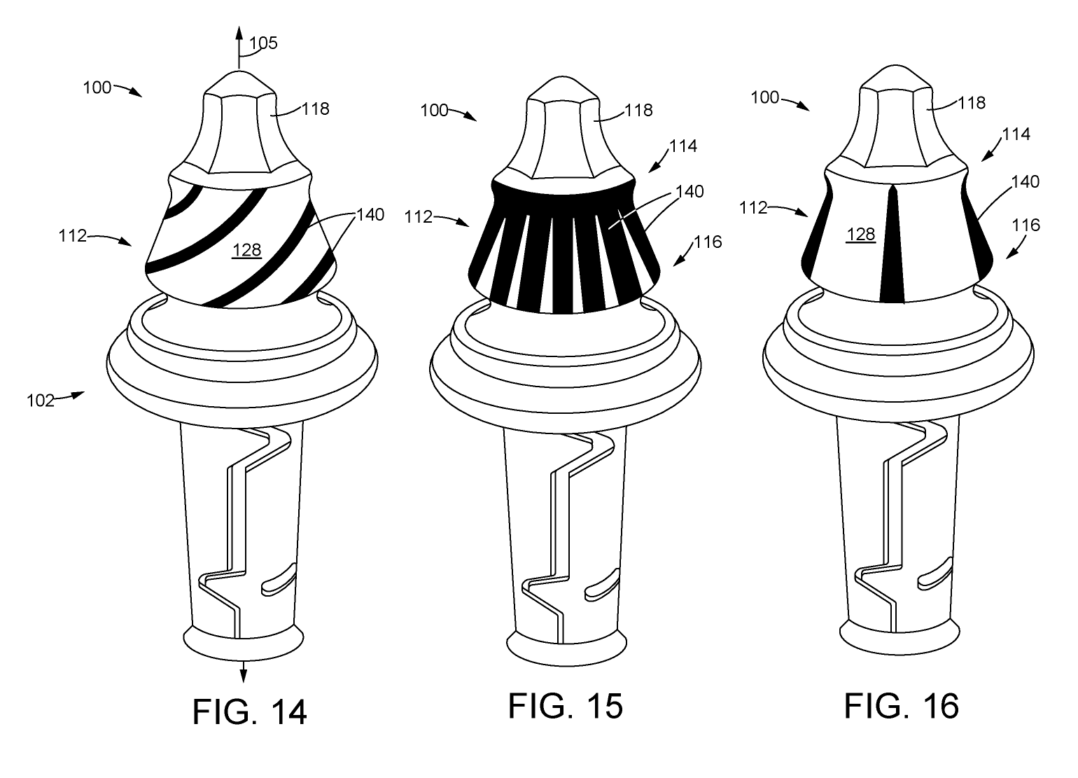

The strips 140 may extend linearly along the outer surface 128 in a direction corresponding to the axis 105, as shown in FIGS. 11-12. Such an arrangement may support rotation of the tool 100 regardless of the direction of rotation (clockwise or counterclockwise) of the tool 100 in use. Alternatively, the strips 140 may be angled or curved with respect to the axis 105 in a helical pattern as shown in FIG. 14. The helical pattern of the strips 140 may have a right-handed twist (as shown) or a left-handed twist depending on the direction of rotation of the cutting tool 100 during use. Specifically, the twist (right-handed or left-handed) of the helical pattern may correspond to the direction of rotation (counterclockwise or clockwise) of the cutting tool 100 in use.

The rotation-assisting strips 140 may be separate from each other as shown in FIGS. 11-14. Alternatively, as shown in FIG. 15, the number and/or widths (w) of the rotation-assisting strips 140 may be great enough such that the strips 140 join or coalesce at the first end 114 of the head portion 112. As yet another possibility, the widths (w) of the strips 140 may vary along their lengths (l₂). For instance, as shown in FIG. 16, the strips 140 may be narrower at the first end 114 and may become progressively wider as they reach the second end 116. Likewise, in other arrangements, the strips 140 may be wider at the first end 114 and may become narrower as they approach the second end 116. Variations such as these, as well as combinations of the aforementioned arrangements, also fall within the scope of the present disclosure.

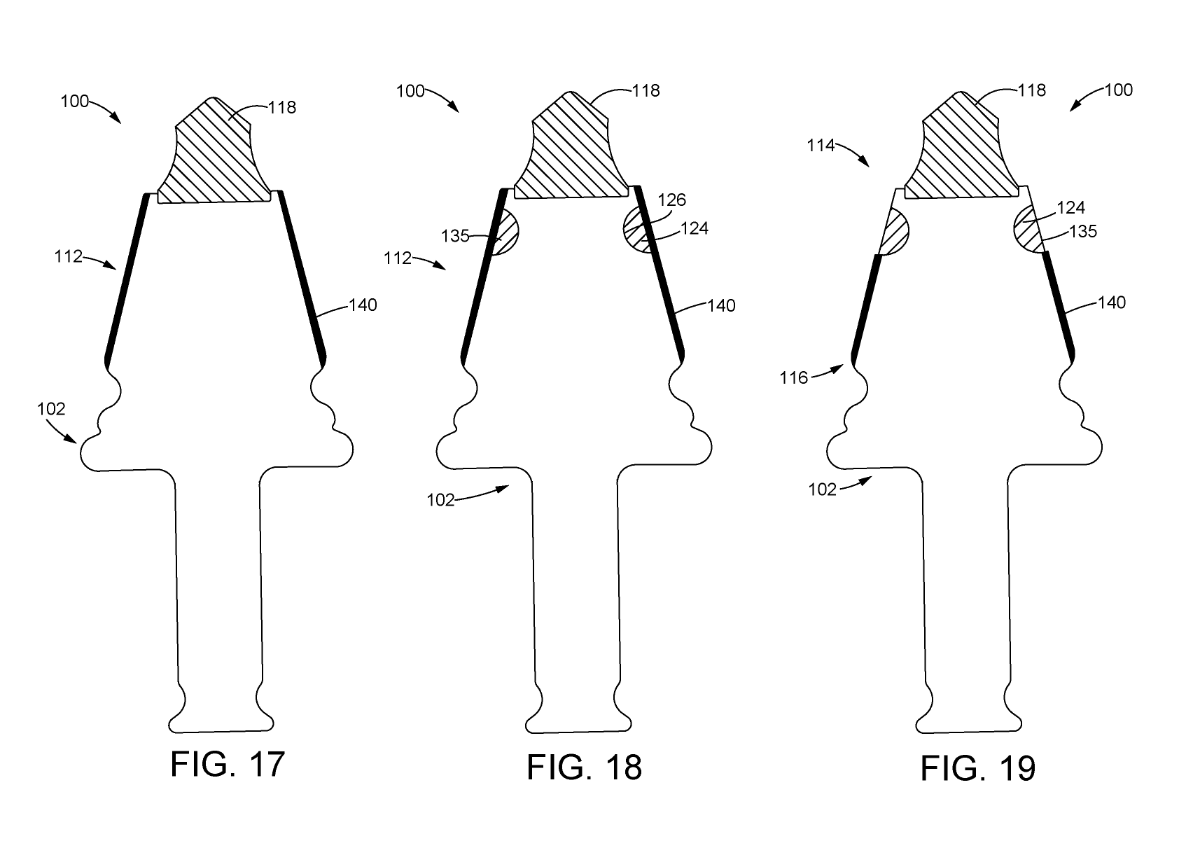

If the head portion 112 lacks the groove 126 and the wear resistant layer 124, the strips 140 may be applied only to the outer surface 128 of the head portion 112 as shown in FIG. 17. Alternatively, if the head portion 112 includes the groove 126 and the wear resistant layer 124, the strips 140 may be applied on at least a portion of both the outer surface 128 of the head portion 112 and the outer surface 135 of the wear resistant layer 124 (see FIG. 18). For example, as shown in FIG. 18, the strips 140 may be applied along the entire length (l₃) of the outer surface 128 including the outer surface 135 of the wear resistant layer 124 with the strips 140 projecting from both of the outer surfaces 128 and 135 (also see FIGS. 11 and 13). As yet another possibility, if the head portion 112 includes the wear resistant layer 124, the strips 140 may be applied only on the outer surface 128 of the head portion 112, as shown in FIG. 19. For example, if the wear resistant layer 124 is proximal to the first end 114, the strips 140 may be applied along the outer surface 128 between the wear resistant layer 124 and the second end 116 of the head portion 112 without contacting the wear resistant layer 124 (see FIG. 19). In other arrangements, the strips 140 may only be applied on the wear resistant layer 124 and not along the outer surface 128 of the head portion 112. Variations such as these, as well as combinations thereof, also fall within the scope of the present disclosure.

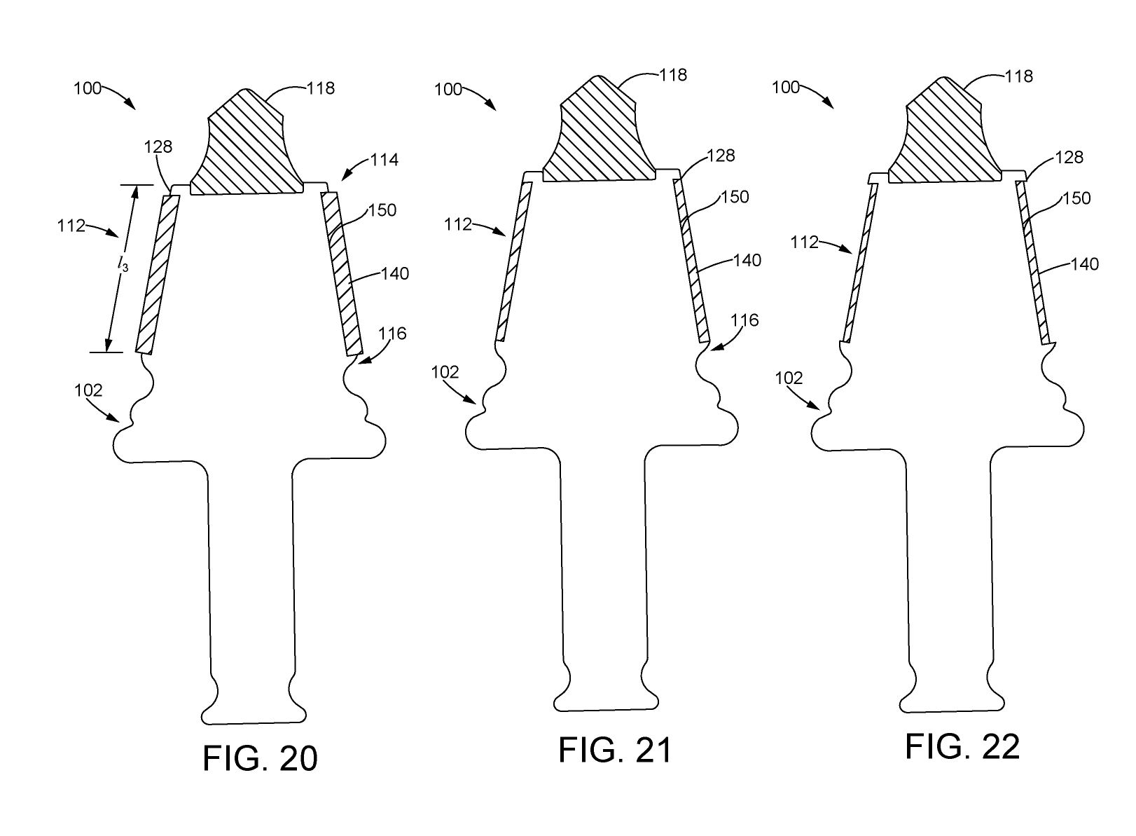

Turning to FIG. 20, in an alternative arrangement, the rotation-assisting strips 140 may be applied or deposited within grooves 150 formed vertically along the outer surface 128 of the head portion 112. In this regard, the number of grooves 150 formed in the head portion 112 may correspond to the number of strips 140. The grooves 150 may extend along the entire length (l₃) of the head portion 112, or somewhere between the first end 114 and the second end 116 of the head portion 112. As with the circumferential groove 126, the grooves 150 may be formed in the head portion 112 by a metal removal process, such as machining, or during the manufacture of the holder 102, such as by molding, casting, or forging. In alternative designs, the grooves 150 may have a helical pattern to support helical strips (see FIG. 14) or they may have widths that vary along the length (l₃) of the head portion 112 (see FIG. 16). The strips 140 applied within the grooves 150 may project from the outer surface 128 of the head portion 112 as shown in FIG. 20. Alternatively, the strips 140 may be flush with the outer surface 128 (see FIG. 21), or the strips 140 may be below the outer surface 128 (see FIG. 22). In the latter configurations, wearing away of the of the metal material of the head portion 112 may allow the strips 140 to become exposed and provide ribs that assist the rotation of the cutting tool 100 through the life of the tool 100. Exposure of the strips 140 may occur with use as the material of the holder 102 may wear away faster than the strips 140. Variations such as these, as well as combinations of the aforementioned arrangements, also fall within the scope of the present disclosure.

The rotation-assisting strips 140 may be formed from a wear resistant material. The wear resistant material of the strips 140 may include a precipitation hardening material, a hard particle material, or a matrix of a hard particle material and a metal. For example, the hard particle material may include a carbide, a boride, a cermet, a carbide former, a boride former, or combinations thereof. The strips 140 may be formed from the same wear resistant material as the wear resistant material of the wear resistant layer 124, although the strips 140 and the wear resistant layer 124 may be formed from different materials as well. Alternatively, the strips 140 may be formed from a metal, a metal alloy, a metal matrix composite material, other types of composite materials, and combinations thereof.

A laser cladding process may be used to apply the rotation-assisting strips 140 to the head portion 112, either directly to the outer surface 128 or within the grooves 150. Specifically, either or both of powder laser cladding and wire laser cladding may be used to deposit the strips 140 on the outer surface 128 (and/or on the outer surface 135 of the wear resistant layer 124) as will be understood by those with ordinary skill in the art. Alternatively, the strips 140 may be applied to the head portion 112 using another deposition technique apparent to those skilled in the art such as, but not limited to, welding, brazing, electroplating, thermal spray coating, or chemical vapor deposition.

Application of the strips 140 and/or the wear resistant layer 124 to the head portion 112 by the aforementioned methods may expose the holder 102 to heat which may soften and alter the microstructure of the metal material of the holder 102. Thus, the holder 102 may be heat treated after application of the strips 140 and/or the wear resistant layer 124 to harden material of the holder 102. The holder 102 may be heat treated either before or after the cutting tip 118 is coupled to the head portion 112 of the holder 102. The heat treatment process may include any one or a combination of heat treatment processes apparent to those skilled in the art such as, but not limited to, annealing, case hardening, precipitation hardening, tempering, normalizing, quench hardening, and combinations thereof.

### INDUSTRIAL APPLICABILITY

In general, the teachings of the present disclosure may find applicability in many industries including, but not limited to, mining, road construction, construction, and excavation. More specifically, the present disclosure may find applicability in any industry using rotatable cutting tools that are subject to wear with use and/or uneven wear caused by poor or inconsistent rotation of the cutting tool.

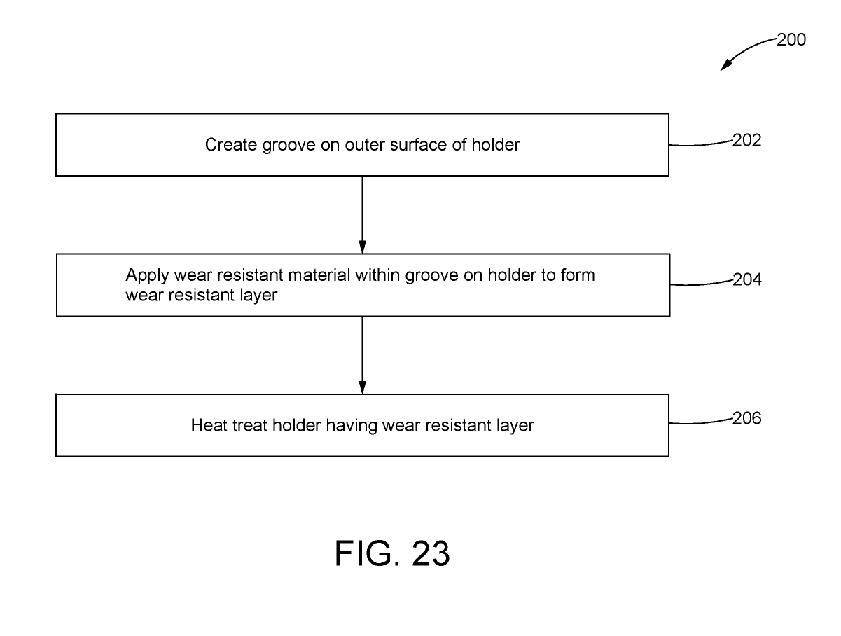

Referring to FIG. 23, a flowchart of a method 200 of selectively hardfacing the holder 102 the cutting tool 100 is shown. Beginning at a block 202, the groove 126 may be created on the outer surface 128 of the holder 102. The groove 126 may be created proximal to the first end 114 of the head portion 112 that receives the cutting tip 118 (see FIG. 3). The groove 126 may extend circumferentially about the head portion 112 of the holder 02. The groove 126 may include a concave arcuate cross-sectional configuration or a conic undercut, as well as various other possible shapes. At a block 204, a wear resistant material may be applied within the groove 126 of the holder 102 to form the wear resistant layer 124. The step of applying the wear resistant material may include laser cladding the wear resistant material within the groove 126 of the holder 102. The wear resistant material may include one of a hard particle precipitating material, or a matrix of a hard particle precipitating material and a metal. In one example, the wear resistant may include at least one of a carbide, a boride, and/or a cermet. At a block 206, the holder 102 having the wear resistant layer 124 may be heat treated. Further, the cutting tip 118 may be coupled to the head portion 112 of the holder 102 prior to the heat treatment. In another example, the cutting tip 118 may be coupled to the head portion 112 after the heat treatment.

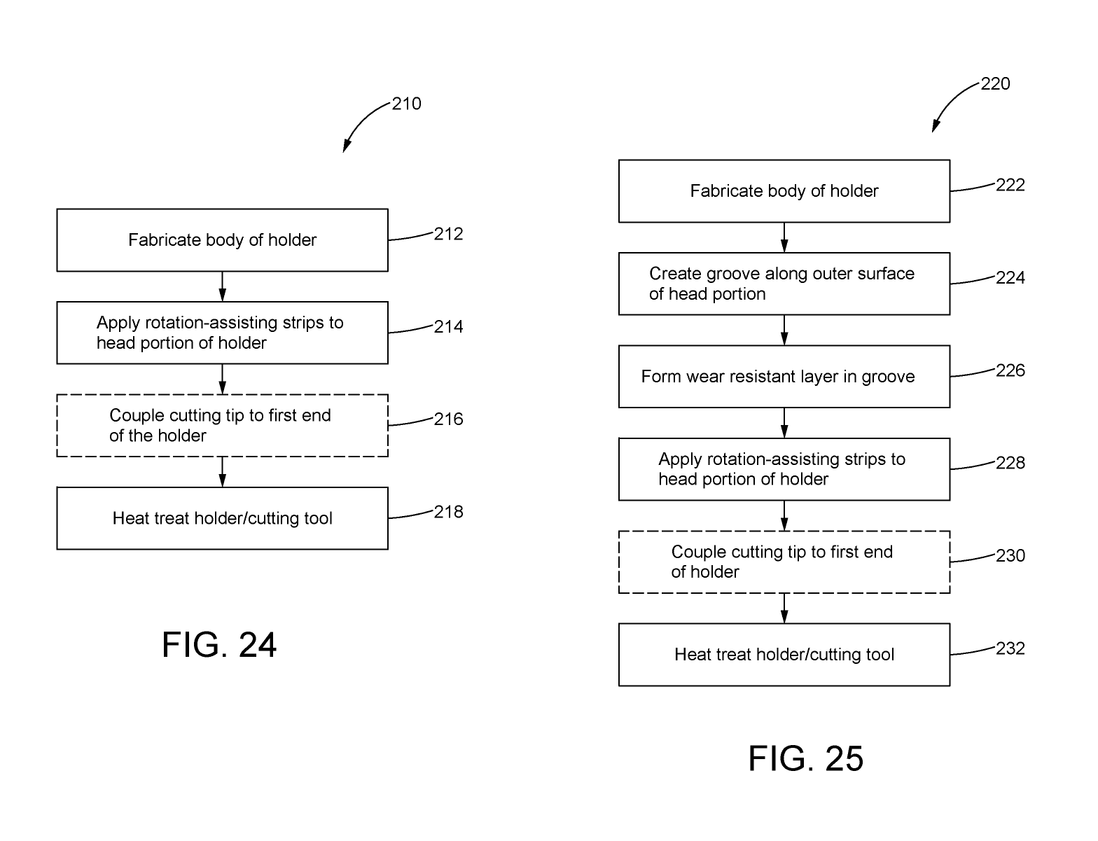

Turning now to FIG. 24, a method 210 that may be used to fabricate the cutting tool 100 with the rotation-assisting strips 140 is shown. Beginning at a first block 212, the body 103 of the holder 102 may be fabricated. For example, the block 212 may involve forging or casting the head portion 112 and the shank portion 104 as a unitary piece. Alternatively, the head portion 112 and the shank portion 104 may be fabricated separately and later assembled to form the holder 102. According to a next block 214, the rotation-assisting strips 140 may be applied to the outer surface 128 (or within the grooves 150) of the head portion 112 by laser cladding or another deposition process. The rotation-assisting strips 140 may be applied as linear lines that extend axially along the outer surface 128 of the head portion 112 between the first end 114 and the second end 116 (see, for example, FIGS. 11-12). Alternatively, the strips 140 may be applied to the outer surface 128 as angled or curved lines in a helical pattern (see FIG. 14).

As the application of the strips 140 to the head portion 112 may expose the holder to heat and cause the metal material of the holder 102 to soften, the holder 102 may be heat treated after the strips 140 are applied according to a next block 218 to harden the metal material of the holder 102. Optionally, the cutting tip 118 may be coupled (e.g., brazed, cemented, etc.) to the first end 114 of the head portion 112 according to a block 216 prior to the block 218. Alternatively, the block 216 may be carried out after the heat treatment.

Turning now to FIG. 25, a method 220 that may be used to fabricate the cutting tool 100 having both the wear resistant layer 124 and the rotation-assisting strips 140 is shown. At a first block 222, the body 103 of the holder 102 including the head portion 112 and the shaft portion 104 may be fabricated. The block 222 may involve forging or casting the head portion 112 and the shank portion 104 as a unitary piece, or it may involve forging or casting the head portion 112 and the shank portion 104 as separate units and assembling the units together. According to a next block 224, the groove 126 may be created along the outer surface 128 of the head portion 112 of the holder 102. For example, the block 224 may involve machining the groove 126 into the head portion 112 proximal to the first end 114 (see FIG. 3). Alternatively, the groove 126 may be forged or cast as a feature of the holder 102 during the block 222. The wear resistant layer 124 may then be formed in the groove 126 according to a next block 226. The block 226 may involve applying the wear resistant layer 124 in the groove 126 by laser cladding or another deposition process.

The rotation-assisting strips 140 may be applied to the head portion 112 according to a block 228. Specifically, the strips 140 may be deposited on either or both of the outer surface 128 of the head portion 112 and the outer surface 135 of the wear resistant layer 124 as explained above. Deposition of the strips 140 on the head portion 112 may be carried out using a laser cladding process or another deposition method apparent to those skilled in the art. If the strips 140 are only be applied on the outer surface 128 of the head portion 112 (see FIG. 13), the blocks 226 and 228 may be carried out in any order.

The holder 102 may then be heat treated following the blocks 226 and 228 according to a block 232. Heat treatment of the holder 102 in this way may harden and toughen the metal material of the holder 102, thereby compensating for at least some of the loss in hardness resulting from the application of the wear resistant layer 124 and the rotation-assisting strips 140 to the holder 102. Optionally, the cutting tip 118 may be coupled (e.g., brazed, cemented, etc.) to the first end 114 of the holder 102 prior to the block 232. Alternatively, the cutting tip 118 may be coupled to the first end 114 of the holder 102 after the block 232 to provide the cutting tool 100.

As disclosed herein, the rotatable cutting tool may include a cutting tip and a holder including a shank portion and a head portion supporting the cutting tip. The cutting tool may be selectively hardfaced by applying a wear resistant layer to a portion of the head portion of the holder that is subject to wear. Specifically, a groove may be formed at the portion of the head portion that is susceptible to wear during use, and a wear resistant material may be applied within the groove to form the wear resistant layer. The wear resistant layer may not alter the overall geometry and design of the holder as it may conform to the shape of the outer surface of the head portion. Thus, the present disclosure provides a cost-effective solution to improve the wear resistance of the cutting tool without disrupting the original geometry of the cutting tool. Specifically, by selectively hardfacing the holder of the cutting tool, a retention time of the cutting tool may be increased. Further, the wear resistant layer may reduce the possibility of failure of the holder due to wear and tear, thereby allowing customers to increase replacement interval time. The wear resistant layer also increases the useful life of the holder and reduces owning and operating costs for the customers.

Alternatively, or in combination with this, the rotatable cutting tool may include rotation-assisting strips presented on the head portion that improve the rotation of the cutting tool as it is drilling or boring into a structure. By promoting rotation of the tool, the strips may prevent uneven wear around the circumference of the cutting tool as is seen in some prior art cutting tools that lack such rotation assistance features. Accordingly, the strips provide an additional cost-effective approach to extend the service life of the cutting tool and reduce the need for replacement of the tool with extended use.

While aspects of the present disclosure have been particularly shown and described with reference to the embodiments above, it will be understood by those skilled in the art that various additional embodiments may be contemplated by the modification of the disclosed machines, systems and methods without departing from the spirit and scope of what is disclosed. Such embodiments should be understood to fall within the scope of the present disclosure as determined based upon the claims and any equivalents thereof.

What is claimed is:

1. A method for fabricating a rotatable cutting tool, comprising:
fabricating a body of a holder of the rotatable cutting tool, the body of the holder extending along an axis and including a head portion and a shank portion, the head portion extending from a first end to a second end, the first end being configured to receive a cutting tip;
applying a plurality of rotation-assisting strips along an outer surface of the head portion that extend between the first end and the second end, the rotation-assisting strips projecting from the outer surface of the head portion; and
heat treating the holder having the plurality of rotation-assisting strips.

2. The method of claim 1, wherein the rotation-assisting strips extend axially between the first end and the second end of the head portion along the outer surface of the head portion.

3. The method of claim 1, wherein the rotation-assisting strips are angled with respect to the axis of the holder in a helical pattern.

4. The method of claim 1, wherein the rotation-assisting strips extend from the first end to the second end of the head portion, the second end of the head portion being axially separated from the shank portion by an upper flange.

5. The method of claim 1, wherein heat treating the holder comprises one or more of annealing, case hardening, precipitation hardening, tempering, normalizing, and quench hardening.

6. The method of claim 1, wherein applying the plurality of rotation-assisting strips along the outer surface of the head portion includes applying the plurality of rotation-assisting strips by laser cladding.

7. The method of claim 1, wherein the rotation-assisting strips are formed from a wear resistant material that includes a hard particle material or a matrix of a hard particle material and a metal.

8. The method of claim 7, wherein the hard particle material includes at least one of a carbide, a boride, and a cermet.

9. The method of claim 1, further comprising coupling the cutting tip to the first end of the head portion prior to heat treating the holder.

10. A rotatable cutting tool including a holder and a cutting tip, the rotatable cutting tool being fabricated by a method comprising:
fabricating a body of the holder, the body extending along an axis and including a head portion and a shank portion, the head portion extending from a first end to a second end, the first end being configured to receive the cutting tip;
creating a groove along an outer surface of the head portion proximal to the first end, the groove extending circumferentially about the head portion;
forming a wear resistant layer in the groove, the wear resistant layer having an outer surface that conforms to the outer surface of the head portion;
applying a plurality of rotation-assisting strips on the outer surface of the head portion and the outer surface of the wear resistant layer, the rotation-assisting strips extending between the first end and the second end and projecting from the outer surface of the head portion and the outer surface of the wear resistant layer; and
heat treating the holder having the wear resistant layer and the rotation-assisting strips.

11. The rotatable cutting tool of claim 10, wherein the rotation-assisting strips extend axially between the first end and the second end of the head portion along the outer surface of the head portion.

12. The rotatable cutting tool of claim 10, wherein the rotation-assisting strips are angled with respect to the axis of the holder in helical pattern.

13. The rotatable cutting tool of claim 10, wherein the rotation-assisting strips extend from the first end to the second end of the head portion, the second end of the head portion being axially separated from the shank portion by an upper flange.

14. The rotatable cutting tool of claim 13, wherein the rotation-assisting strips are joined together at the first end of the head portion.

15. The rotatable cutting tool of claim 10, wherein applying the plurality of rotation-assisting strips further comprises applying at least four of the rotation-assisting strips along the outer surface of the head portion and the outer surface of the wear resistant layer.

16. The rotatable cutting tool of claim 10, wherein the wear resistant layer and the rotation-assisting strips are both formed from a wear resistant material that includes a hard particle material or a matrix of a hard particle material and a metal.

17. The rotatable cutting tool of claim 16, wherein the hard particle material includes at least one of a carbide, a boride, and a cermet.

18. The rotatable cutting tool of claim 17, wherein forming the wear resistant layer in the groove comprises forming the wear resistant layer by laser cladding, and wherein applying the plurality of rotation-assisting strips along the outer surface of the head portion and the outer surface of the wear resistant layer comprises forming the rotation-assisting strips by laser cladding.

19. The rotatable cutting tool of claim 18, further comprising coupling the cutting tip to the first end of the head portion prior to heat treating the holder.

20. A rotatable cutting tool, comprising:
a holder having a body extending along an axis and including a head portion and a shank portion, the head portion extending from a first end to a second end;
a wear resistant layer extending circumferentially about the head portion proximal to the first end of the head portion;
a plurality of rotation-assisting strips extending axially along the outer surface of the head portion between the first end and the second end, the rotation-assisting strips projecting from the outer surface of the head portion, the holder being heat treated after application of the wear resistant layer and the rotation-assisting strips; and
a cutting tip coupled to the first end of the head portion.
